(19) United States
(12) Patent Application Publication
(10) Pub. No.: US 2015/0051950 A1
(43) Pub. Date: Feb. 19, 2015

(54) SYSTEM AND METHOD FOR ANALYZING AND PREDICTING CONSUMER BEHAVIOR

(71) Applicant: H.J. HEINZ COMPANY, Pittsburgh, PA (US)

(72) Inventors: Stacey Cox, Allison Park, PA (US); Wendy Delvecchio, Kalamazoo, MI (US)

(21) Appl. No.: 14/386,517

(22) PCT Filed: Mar. 14, 2013
(86) PCT No.: PCT/US2013/031549

§ 371 Date: Sep. 19, 2014

Related U.S. Application Data
(60) Provisional application No. 61/614,150, filed on Mar. 22, 2012.

(51) Int. Cl. G06Q 30/02; G06Q 50/12

(52) U.S. Cl. CPC G06Q 30/0202; G06Q 50/12
USPC 705/7.31

(57) ABSTRACT

Method of analyzing and predicting consumer behavior includes receiving a plurality of consumer answers to a plurality of questions, each answer having a unique consumer identity, each question corresponding to: a lifestyle attitude sector having a plurality segments; a consumer mindset sector having segments; a product preference sector having segments; an influencer sector having segments; and a need state sector having segments. The method further includes assigning a value to each user answer, creating a composite value associating the consumer identity with a particular lifestyle attitude segment, consumer mindset segment, product preference segment, influencer segment, and need state segment, and comparing the composite value with a plurality of product values each associated with a respective plurality of products in a product database.

### CROSS-REFERENCE TO RELATED APPLICATIONS

The instant application is a PCT International Application based on and claims the benefit of priority of U.S. provisional application No. 61/614,150, filed Mar. 22, 2012, the disclosure of which is hereby expressly incorporated by reference hereto in its entirety.

### BACKGROUND

1. Field of the Disclosure

The present disclosure relates to the field of analyzing and predicting consumer behavior.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

2. Background Information

Producers, such as food and beverage producers, have consistently tried to keep up with the product and service desires of consumers by providing the consumer with the most appropriate and desirable products and services; however, such is not an easy task, given the fluctuation of consumer eating behavior as a whole population and individually. Thus, producers often engage in expensive and time-consuming market research to determine the most appropriate product or service, in an effort to avoid introducing inappropriate products to the market. Further, market researchers and/or producers have typically performed market research for each type of product, a time-consuming and expensive process. Producers are also faced with the challenge of identifying the most appropriate test subjects to test a product. For example, while a particular type of beef entry may be market appropriate, such cannot be known when the test-marketing subject is a vegetarian. There has thus arisen a need to more accurately identify consumers to test market products and services.

### SUMMARY OF THE DISCLOSURE

A feature of the disclosure addresses a business issue, in that producers can move faster to market with larger, more sustainable products by providing a framework to navigate and predict eating behavior and respective food choice, and to accurately anticipate what the consumer will prefer and eliminate wasteful product development. As used herein, “product” may refer to any product or service, including but not limited to items/products, marketing messages, services, package, entertainment services and the like, and “producers” refers to any entity capable of providing or otherwise affiliated with such products or services. Also as used herein, “consumer” may refer to any individual or entity capable of consuming any such products or services, including but not limited to retail, wholesale and foodservice customers and operators, research vendors and suppliers, and other external business partners, such as advertising and promotion agency partners, copackers, and the like.

A feature of the disclosure will continually identify and track consumer needs, provide more relevant and targeted products and messaging, prioritize producer resources and technologies, enable producers to appropriately react to fads vs. trends, and allow the producer to rapidly and accurately engage the consumer with respect to product preferences. By doing so, this feature satisfies the need to better predict eating behavior and leverage consumer food trends, influence the consumer to choose a producer's product and make research more efficient in cost and time.

Consumers can be segmented by their food attitudes and eating behaviors. Internal and external factors in life influence eating. For example, internal factors can include spirituality as well as a consumer's stage in life, and external factors can include government recommendations and the latest in science and technology.

Accordingly, a feature of the disclosure provides a method of analyzing and predicting consumer behavior, including receiving a plurality of consumer answers to a corresponding plurality of questions, each answer of the plurality of consumer answers input by a consumer having a unique consumer identity, each question of the plurality of questions corresponding to at least one of the following sectors: a lifestyle attitude sector having a plurality of lifestyle attitude segments, each of which correspond to a different consumer attitude toward a lifestyle; a consumer mindset sector having a plurality of consumer mindset segments, each of which corresponds to a different manner in which the consumer prefers to receive product information; a product preference sector having a plurality of product preference segments, each of which corresponds to a different product quality desired to be experienced by the consumer; an influencer sector having a plurality of influencer segments, each of which corresponds to a different factor that influences the consumer's consuming behavior; and a need state sector having a plurality of need state segments, each of which corresponds to a different consumer emotional need on a consuming occasion; assigning a value to each user answer; creating, based on the assigned values of each user answer and using a computer processor, a composite value associating the consumer identity with a particular lifestyle attitude segment, consumer mindset segment, product preference segment, influencer segment, and need state segment; and comparing, via a comparator, the composite value with a plurality of product values each associated with a respective plurality of products in a product database. In an embodiment, the product is a food product or message.

In the method according to a feature of the invention, each lifestyle attitude segment of the plurality of lifestyle attitude segments have a different taste percentage value, convenience percentage value and health percentage value, wherein the taste, convenience and health percentage values total 100%.

The method may further include identifying, based on the compared composite value and product value, a corresponding product of the product database. Additionally, the consumer may be presented with the identified corresponding product. Also, the consumer's judgment regarding the identified corresponding product may be recorded.

According to a feature, the plurality of lifestyle attitude segments may have five lifestyle attitude segments, the plurality of consumer mindset sectors may have five consumer mindset segments, the plurality of product preference sectors may have four product preference segments, each segment having a food olfactory strength value and a food mechanical value, the plurality of product preference sectors further may have two product size preference values (whole versus piece/chopped/cut up/small piece), the plurality of influencer segments may have twenty influencer segments, each influencer segment having one or more of an internal influence and an external influence, and/or the plurality of need state segments may have eight need state segments, each need state segment corresponding to a personal dimension in a range between pleasure and control, and further corresponding to a social dimension in a range between individuality and conformity.

Also, the product may be one of a marketing message, a service and a package.

Another aspect of the disclosure provides at least one processor for analyzing and predicting consumer behavior, the processor configured to: receive a plurality of lifestyle attitude segment values, each of which correspond to a different consumer attitude toward a lifestyle; receive a plurality of consumer mindset segment values, each of which corresponds to a different manner in which the consumer prefers to receive product information; receive a plurality of product preference segment values, each of which corresponds to a different product quality desired to be experienced by the consumer; receive a plurality of influencer segment values, each of which corresponds to a different factor that influences the consumer's consuming behavior; and receive a plurality of need state segment values, each of which corresponds to a different consumer emotional need on a consuming occasion.

Yet another aspect of the disclosure provides at least one computer that executes an application for generating a composite consumer behavior image indicator, having: a memory that stores the application; and a processor that executes the application, wherein the application, when executed by the processor, causes the computer at least to: generate one of a plurality of lifestyle attitude sub-images, each of which represents a different consumer attitude toward a lifestyle; generate one of a plurality of consumer mindset sub-images, each of which represents a different manner in which the consumer prefers to receive product information; generate one of a plurality of product preference sub-images, each of which represents a different product quality desired to be experienced by the consumer; generate at least one of a plurality of influencer sub-images, each of which represents a different factor that influences the consumer's consuming behavior; and generate one of a plurality of need state sub-images, each of which represents a different consumer emotional need on a consuming occasion, wherein: the generated lifestyle attitude sub-image, consumer mindset sub-image, product preference sub-image, influencer sub-image, and need state sub-image together form the composite consumer behavior image (or number score, index, or characterization).

A further aspect of the disclosure provides at least one computer that executes an application for analyzing and predicting consumer behavior, having at least one memory that stores the application; and at least one processor that executes the application, wherein the application, when executed by the at least one processor, causes the computer at least to: receive a plurality of consumer answers to a corresponding plurality of questions, each answer of the plurality of consumer answers input by a consumer having a unique consumer identity, each question of the plurality of questions corresponding to at least one of the following sectors: a lifestyle attitude sector having a plurality of lifestyle attitude segments, each of which correspond to a different consumer attitude toward a lifestyle; a consumer mindset sector having a plurality of consumer mindset segments, each of which corresponds to a different manner in which the consumer prefers to receive product information; a product preference sector having a plurality of product preference segments, each of which corresponds to a different product quality desired to be experienced by the consumer; an influencer sector having a plurality of influencer segments, each of which corresponds to a different factor that influences the consumer's consuming behavior; and a need state sector having a plurality of need state segments, each of which corresponds to a different consumer emotional need on a consuming occasion; assign a value to each user answer; create, based on the assigned values of each user answer and using a computer processor, a composite value associating the consumer identity with a particular lifestyle attitude segment, consumer mindset segment, product preference segment, influencer segment, and need state segment; and compare the composite value with a plurality of product values each associated with a respective plurality of products in a product database.

Still another feature of the disclosure provides at least one non-transitory computer readable medium for analyzing and predicting consumer behavior, the medium having: a receiving code segment which, when executed by the computer, receives a plurality of consumer answers to a corresponding plurality of questions, each answer of the plurality of consumer answers input by a consumer having a unique consumer identity, each question of the plurality of questions corresponding to at least one of the following sectors: a lifestyle attitude sector having a plurality of lifestyle attitude segments, each of which correspond to a different consumer attitude toward a lifestyle; a consumer mindset sector having a plurality of consumer mindset segments, each of which corresponds to a different manner in which the consumer prefers to receive product information; a product preference sector having a plurality of product preference segments, each of which corresponds to a different product quality desired to be experienced by the consumer; an influencer sector having a plurality of influencer segments, each of which corresponds to a different factor that influences the consumer's consuming behavior; and a need state sector having a plurality of need state segments, each of which corresponds to a different consumer emotional need on a consuming occasion; an assigning code segment that assigns a value to each user answer; a creating code segment which, when executed by the computer, creates, based on the assigned values of each user answer and using a computer processor, a composite value associating the consumer identity with a particular lifestyle attitude segment, consumer mindset segment, product preference segment, influencer segment, and need state segment; and a comparing code segment which, upon executed by the computer, compares, using a comparator, the composite value with a plurality of product values each associated with a respective plurality of products in a product database.

### BRIEF DESCRIPTION OF THE DRAWINGS

FIG. 1 is an illustrative embodiment of a general purpose computer system, according to an aspect of the present disclosure;

FIG. 2 is a schematic view of an eating behavior framework, according to an aspect of the present disclosure;

FIG. 3 is an alternative schematic view of an eating behavior framework, according to an aspect of the present disclosure;

FIG. 4 shows an example of need state segments;

FIG. 5 shows a flowchart demonstrating a method of analyzing and predicting consumer behavior;

FIG. 6 is a graphical representation of each of the five sectors of an aspect of the disclosure;

FIG. 7A shows internal influencers icons according to an aspect of the disclosure; and

FIG. 7B shows external influencers icons according to an aspect of the disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

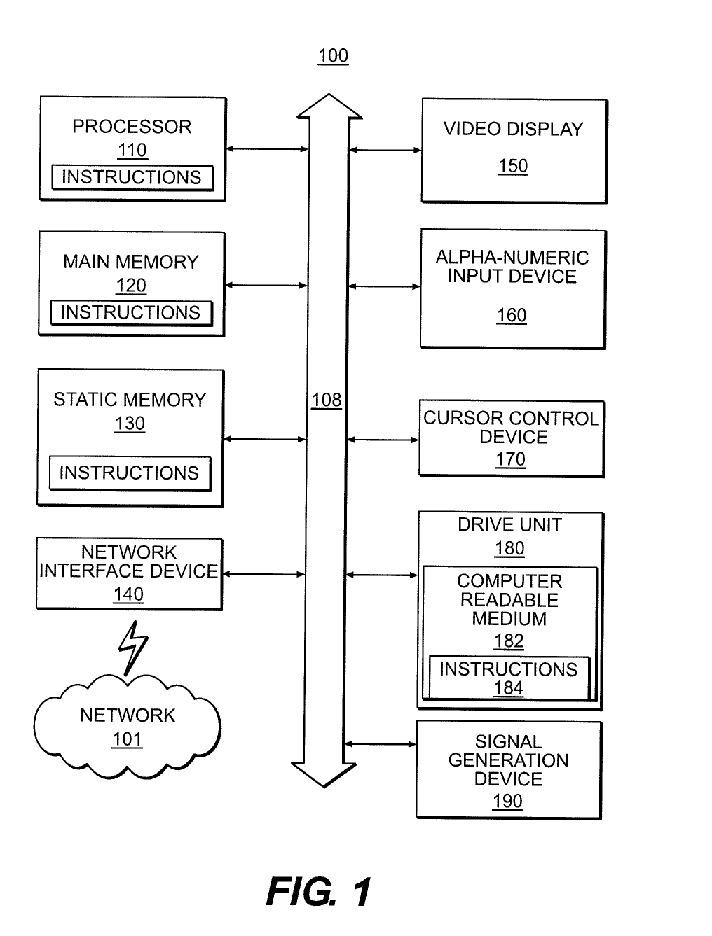

Referring to the drawings wherein like characters represent like elements, FIG. 1 is an illustrative embodiment of a general purpose computer system, on which a system and method for method of analyzing and predicting consumer behavior (also referred to as an “eating behavior framework”) can be implemented, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system may operate in the capacity of a server or as a client user computer in a server-client user network environment, or as a peer computer system in a peer-to-peer (or distributed) network environment, including but not limited to femtocells or microcells. The computer system 100 can also be implemented as or incorporated into various devices, such as a personal computer (PC), a tablet PC, a set-top box (STB), a personal digital assistant (PDA), a smartphone, a mobile device, a global positioning satellite (GPS) device, a palmtop computer, a laptop computer, a desktop computer, a communications device, a wireless telephone, smartphone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display (video display unit) 150, such as a liquid crystal display (LCD), an organic light emitting diode (OLED), a flat panel display, a solid state display, or a cathode ray tube (CRT). Additionally, the computer system 100 may include an input (input device) 160, such as a keyboard or touchscreen, and a cursor control/pointing controller (cursor control device) 170, such as a mouse, trackball, touchscreen, touchpad or trackpad. The computer system 100 can also include storage, such as a disk drive unit 180, a signal generator (signal generation device) 190, such as a speaker or remote control, and a network interface (e.g., a network interface device) 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which one or more sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 104 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video and/or data over the network 101. Further, the instructions 184 may be transmitted and/or received over the network 101 via the network interface device 140.

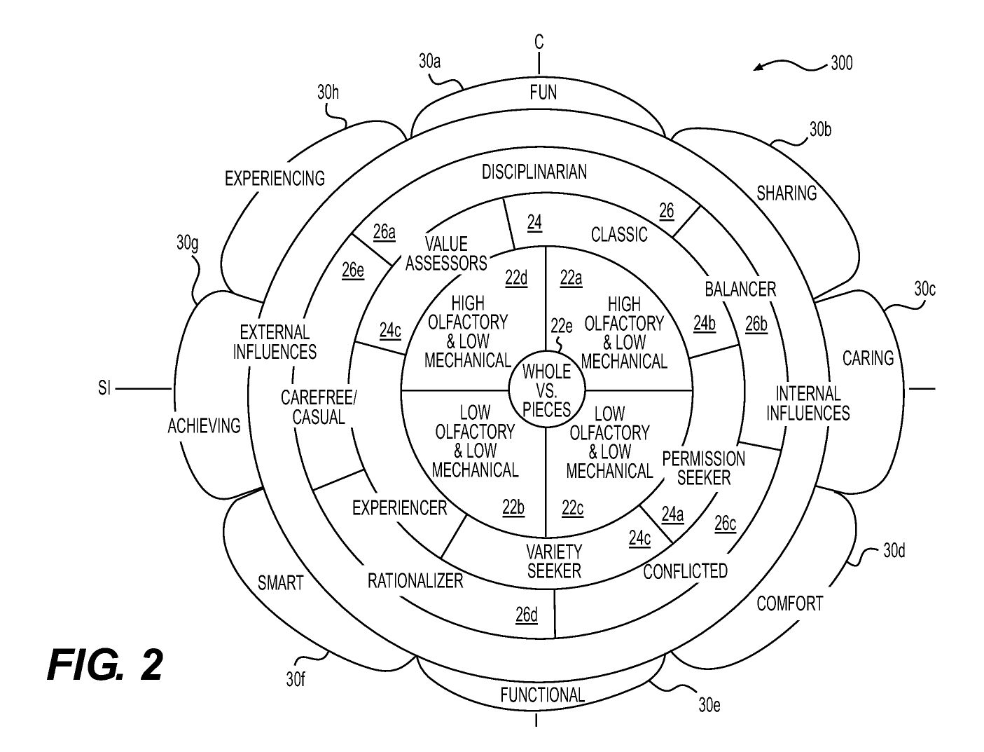

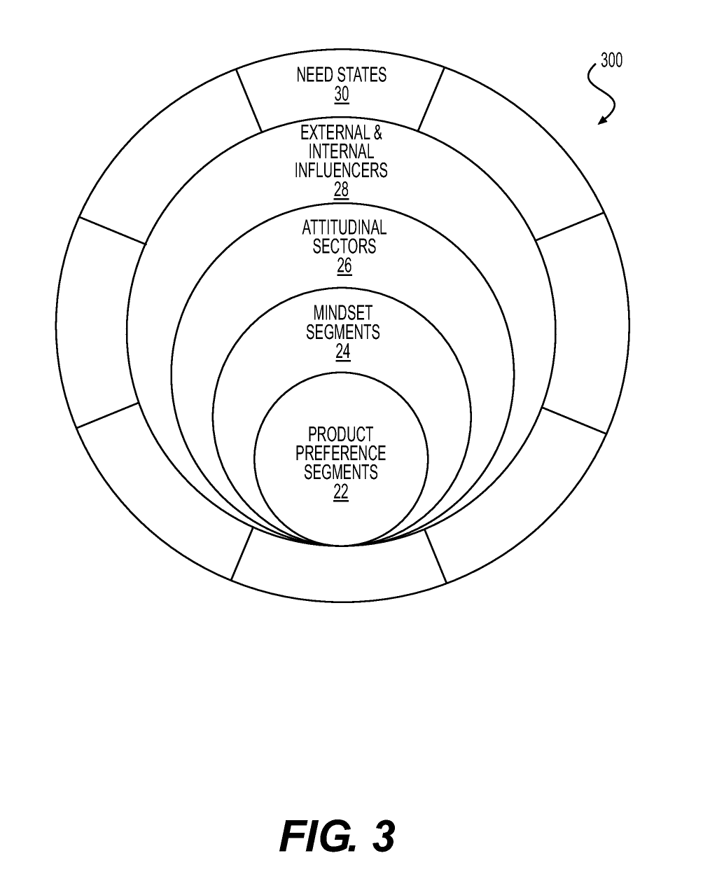

FIGS. 2-3 are schematic views of an eating behavior framework 300, according to an aspect of the present disclosure, wherein nested rings representing five eating behavior sectors 22, 24, 26, 28 and 30 are shown. Referring to FIG. 2, the innermost ring represents consumer product preferences 22, the next outer ring represents consumer mindsets 24, the next outer ring represents consumer lifestyle attitudes 26, the next outer ring represents influencers 28 and the outermost ring represents consumer need states 30. It is noted that each ring 22, 24, 26, 28, 30 can rotate relative to the other for not only based on different consumers, but can rotate for each individual consumer, depending on the individual consumer's tastes for each type or produce or service (or period in time), as further described below. Each of the five eating behavior sectors are described in further detail below, and each sector includes a plurality of segments. It is noted that the terms “sector” and “segment” are used in the specification for consistency and ease of understanding to describe a set/member relationship; however, it is also noted that other terms to describe the sectors and segments of the disclosure may be applied without limitation, including but not limited to “grouping,” “set,” “subset,” “filter,” “member” and “factor.”

### Product Preference Sector

The Product preference sector 22 is divided into four product preference segments 22a, 22b, 22c and 22d and is defined by a specific sensation the consumer experiences from food stimulation. Each segment 22a, 22b, 22c and 22d includes an olfactory (includes aroma, flavor, taste, aftertaste and related attributes) component and mechanical (includes mouth activity, texture, feeling factor and related attributes) component, as follows: high olfactory/high mechanical 22a, low olfactory/low mechanical 22b, low olfactory/high mechanical 22c and high olfactory/low mechanical 22d. As used herein, “texture” is defined as the sensory manifestation of the structure or inner makeup of products in terms of their reaction to stress, measured as mechanical properties by the kinesthetic sense in the muscles, tactile feel properties measured as geometrical properties and moisture properties by the tactile nerves in the surface of the skin of the hand, lips, and tongue. It has been determined that all consumers fall into one of these four product preference segments, and that such behavior is innate or learned very early in life. Further, product preference segments may be physiological, psychologically, neurologically and/or genetically linked. Another component of the product preference sector includes whole/piece preference, which transcends the other segments 22a-22d. It has also been determined that the product preference drives consumer satisfaction.

Table 1 below provides examples of the product preference sector.

TABLE 1

| Segment | Definition |
|---|---|
| High Olfactory & High | Seeks highly stimulating foods for both the |
| Mechanical 22a | nose & mouth |
| Low Olfactory & High | Seek low aroma/flavor, but high mouth activity |
| Mechanical 22c | (texture) stimulating foods |
| High Olfactory & Low | Seek high aroma/flavor, but low in mouth |
| Mechanical 22d | activity (texture) stimulation |
| Low Olfactory & Low | Seek foods which provide low nose |
| Mechanical 22b | and mouth stimulation |
| Food Piece Size | Seek whole pieces or food cut into pieces |
| (Whole vs. Piece) | |

In research, the four segments 22a, 22b, 22c and 22d may be initially presented to test market subjects for a fast hit rate. In this regard, as an example, if the product to be tested is a hot sauce, then test market subject falling into segments 22b and 22c may be eliminated from the test. It is also noted that a single consumer will generally fall only into one of product preference segments 22a, 22b, 22c and 22d, regardless of the type of product. They will however, eat out of their innate product preference segment given the situation and choices, but more than likely, not be truly satisfied.

An aspect of the disclosure also allows the producer to design product packaging and advertising based on the different product preference segments.

For example, if research determines that of the four product preference segments, members of product preference segment 22c are most likely to prefer beef pot roast, then an appropriate product description, such as the one above, can be used to further target to the product to the appropriate consumer. In this way, a feature of the disclosure allows the producer to validate the size of any given product preference segment 22a-22d, and to target a product to the product preference segment having the greatest proportion of members.

### Mindset Sector

The mindset sector 22 is divided into five mindset segments 24a, 24b, 24c, 24d and 22e and is defined by a specific way the consumer prefers to be “messaged” or presented with a product or service description. It is noted that the five mindset segments 24a, 24b, 24c, 24d and 22e are used with permission from the Understanding & Insight Group, LLC. The five mindset segments are as follows: permission seeker 24a, classic 24b, variety seeker 24c, experiencer 24d and value assessor 24e. The five mindset segments are defined below in Table 2:

TABLE 2

| Mindset | Definition |
|---|---|
| Permission Seeker 24a | Seeking “source” of assurance that it is okay to |
| | select and/or consume |
| Classic 24b | Seeking assurance of the traditional category |
| | experience |
| Variety Seeker 24c | Seeking variety in the experience |
| Experiencer 24d | Seeking the guaranteed experience (brand gives |
| | them the assurance of the experience) |
| Value Assessor 24e | Seeking assurance of value |
| | (not being “ripped off”) in the monetary exchange |

It is noted that all consumers fall into one of the five mindsets, and that a single consumer may fall into different mindset segments 24a, 24b, 24c, 24d and 22e, depending on the type of product or service (e.g., food vs. beverage, or automobile vs. television program), i.e., consumers generally prefer to be messaged to in different ways depending on the type of product or service. Knowledge of the appropriate mindset segments provides the producer with the ability to target the intent of the product message based on what the consumer needs to hear about the product or service.

An aspect of the disclosure also allows the producer to design product packaging and advertising based on the different mindset segments. Further, an aspect of the present disclosure allows product descriptions for different product preferences 22 and different mindsets 24.

It is noted that a feature of the disclosure allows the producer to validate the size of any given mindset segment 24a-24e, and to target a product to the mindset having the greatest proportion of members.

### Attitudinal Sector

The attitudinal sector 26 is divided into five lifestyle attitude (or attitudinal) segments 26a, 26b, 26c, 26d and 26e and is defined by a specific attitude a consumer has toward life, food, products and/or services. The five attitudinal segments are as follows: disciplinarian 26a, balancer 26b, conflicted 26c, rationalizer 26d and carefree/casual 26e. The five attitude segments are defined below in Table 3:

TABLE 3

| Sector | Definition |
|---|---|
| 5—Disciplinarian | Leading the ultimate healthy lifestyle appears effortless |
| | for this sector. |
| | Make choices that enable them to feel as though they |
| | are ultimately in control of their lives |
| 4—Balancer | Balances nutrition with taste and convenience. |
| | They can be adventurous. When cooking they like to |
| | use fresh ingredients and cook from scratch. |
| 3—Conflicted | Has good intentions around life choices - food, |
| | nutrition, purchases, etc. |
| | Concerned about image and try to manage their |
| | resources (money, time, energy). |
| | Don't always follow through on decisions due to their |
| | spontaneous nature. |
| 2—Rationalizer | Rationalizes their eating habits and choices. |
| | When have time to eat healthy, they will: but when |
| | pressed for time, will focus on easy convenient meals |
| | or reasonable substitutes |
| 1—Carefree/ | Looks for good taste and fulfillment. |
| Casual | Seek solutions in life to help them get through the day. |
| | Tend not to move outside of their sector rapidly. |

It has been determined that all consumers generally fall into one of the five attitudinal segments, and that there are degrees of fit within the segments. Fit is dependent on the tradeoff between: Taste, Convenience or Health. For consumers in the sectors, food needs to be either 1) instantly gratifying, 2) instantly gratifying with some short term sustaining, or 3) long term sustaining (i.e., beyond today). Further, when a consumer experiences life-altering event and/or others shifts/events/changes that occur in the influencers, they will often shift into another attitudinal segment.

A feature of the disclosure allows the producer to validate the size of any given attitudinal segment 26a-26e and to target a product to the attitudinal segment having the greatest proportion of members

### Influencer Sector

The influencer sector 28 is divided into twenty influencer segments 28a-28t and is defined by a specific factor that influences a consumer's consuming behavior. The 20 influencer segments are defined below in Table 4:

TABLE 4

| Influencer | Definition |
|---|---|
| 28a. Body | Mass culture, body image, |
| Image | movie, TV and exercise |
| 28b. Life Roles | Role a person plays in their |
| | day-to-day life (mother, |
| | caregiver, etc.) |
| 28c. Life | Implications on children |
| Stages | (under the age of 18) |
| | through elderly (over 65) |
| 28d. Culture | The environment that the |
| | individual lives in |
| 28e. Loci of | Is this a heart or head |
| Decision | issue? |
| | Emotional or Intellectual |
| 28f. | Concerned with or |
| Spirituality | affecting the spirit or soul |
| 28g. | Suited to your comfort, |
| Convenience/ | purpose or needs |
| Simplicity | |
| 28h. Internal | Factors the individual |
| | considers when making |
| | choices |
| 28i. Economic | Concerned with the |
| | “worldly” necessities of |
| | life includes transportation |
| | and food dollars at home |
| | and away |
| 28j. | Influenced by regulatory |
| Regulatory | agencies |
| 28k. Litigation | Having to do with legal |
| | aspects of the subject |
| 28l. Political | Having to do with |
| | government/political |
| | issues |
| 28m. Media | Involving the written |
| | text in the form of |
| | newspapers, books, |
| | magazines and web |
| 28n. Health | Healthcare providers, |
| Care | their agencies, and other |
| | related professions |
| 28o. Business | Organization and groups |
| Associations | affiliated with the |
| | category/topic |
| 28p. Trade/ | Sell channels; Markets |
| channel | |
| 28q. | Institutions and |
| Academic, | organizations that are |
| Science & | responsible for creation |
| Technology | and dissemination of |
| | fact based information |
| 28r. | Including: nutrients per |
| Population | capita per day |
| Stats | Household size, cohort |
| | classification, household |
| | finances |
| 28s. Food | Food preparation: time, |
| Industry | equipment, ingredients, |
| | grocery, cookbooks, and |
| | restaurant chains |
| | Food Safety, Food |
| | industry timeline |
| 28t. Producer | Relevant business |
| | initiatives that relate to |
| | timeline |

It has been determined that consumer diets have cycled over the past 1000 years, cycling for the majority of the time between high fiber (whole grain/fruit and vegetable), nutrient-dense (superfood), calorie control, food substitutes (e.g., liquid diets) and high protein. The influencer sector 28 is based on the cause and effect of diet cycles throughout past 1000 years. The periodic cycling of diets based on the influencers will predict changes in eating behaviors and potential shifts in attitudinal sectors 26.

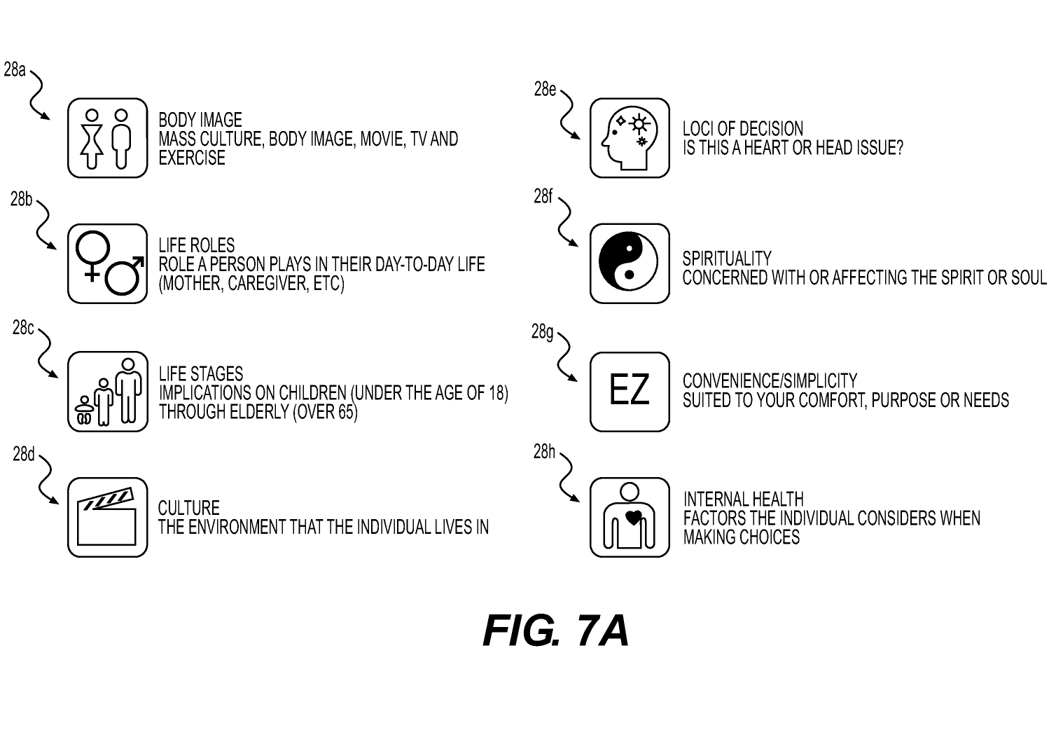

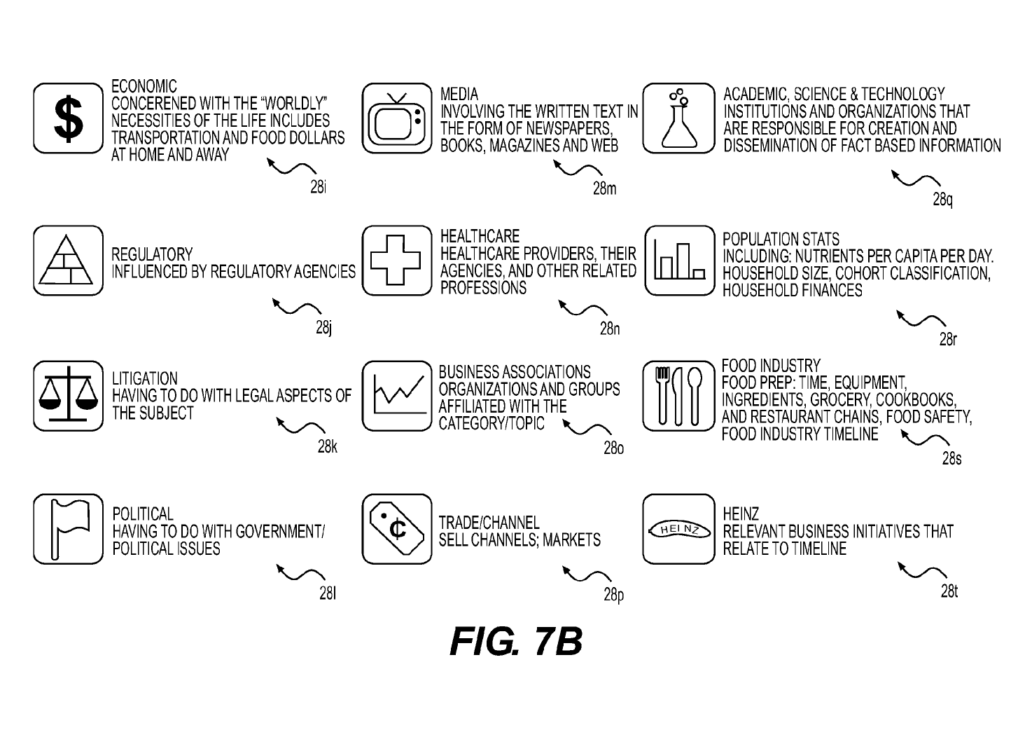

Segments 28a-28h are internal influencers (shown in FIG. 7A) that influence the individual directly and have a stronger impact on eating behavior than external influencers 28i-28t (shown in FIG. 7B). It is noted that shifts in economics 28i and health care 28n are two of the larger influencers on diet cycles.

According to an aspect of the disclosure, producers are able to track influencer segments 28a-28t to predict behavior shifts in eating (dieting). These shifts can be used to reallocate resources against the most likely eating behavior changes/diet patterns (diet cycling).

### Need State Sector

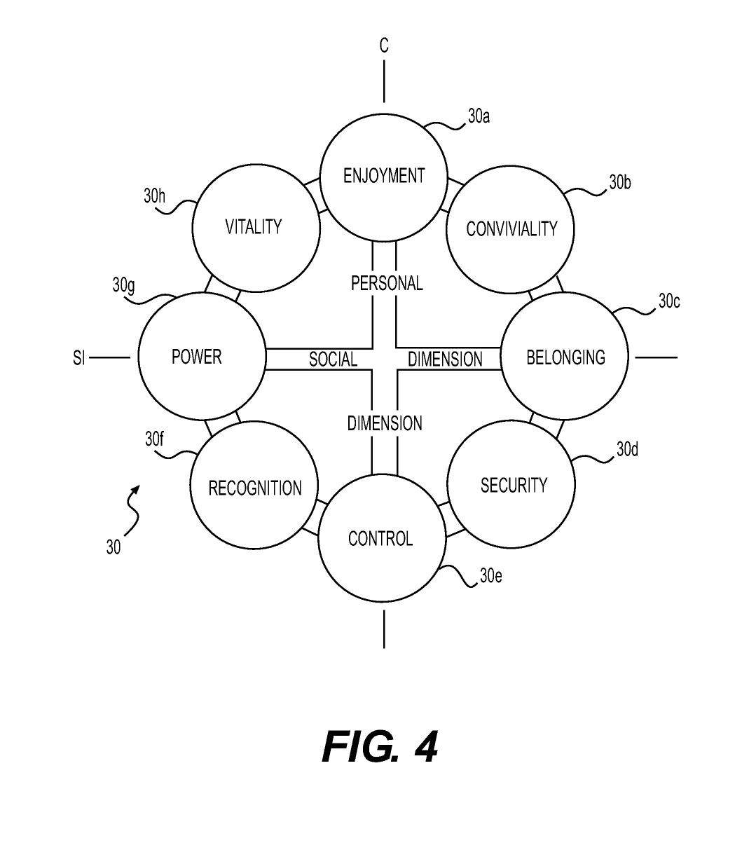

The need state sector 30 is divided into eight need state segments 30a-30h and is defined by the influence of consumer's emotional needs on a given eating occasion on a consumer's product choice. The need state segments 30a-30h were created by Synovate, and the eight need state segments are as follows: fun/pleasure/enjoyment 30a, sharing/connecting/conviviality 30b, caring/belonging 30c, comfort/security 30d, functional/control 30e, smart/recognition 30f, achieving/power 30g and experiencing/vitality 30h. As viewed in FIGS. 2 and 4, the axis bisecting 30c and 30g is the social interaction axis SI, which shifts from belonging/fitting in (the left side of FIGS. 2 and 4) to individuality/standing out (the right side of FIGS. 2 and 4). Also as viewed in FIGS. 2 and 4, the axis bisecting 30a and 30e is the control axis C, which shifts from liberation (the top of FIGS. 2 and 4) to restraint (the bottom of FIGS. 2 and 4). The two axes SI, C interact with each other such that the upper left section of FIGS. 2 and 4 is directed to self-expression, the upper right section of FIGS. 2 and 4 is directed to participation and membership, the lower left section of FIGS. 2 and 4 is directed to searching for recognition, and the lower right section of FIGS. 2 and 4 is directed to retreating from others.

As an example, a consumer quickly eating a bowl of soup at their desk prior to running off to a meeting would fall into the functional/control segment 30e, whereas a consumer relaxing by the fireplace on vacation while enjoying a hot bowl of tomato soup and reading a book would fall into the fun/pleasure segment 30a. All consumers will generally cycle through all eight need state segments 30a-30h in a two week period. Further, need state segments 30a-30h manifest themselves differently across each attitudinal segment 26a-26e, but reside in all attitudinal segments.

### Implementation of the Framework

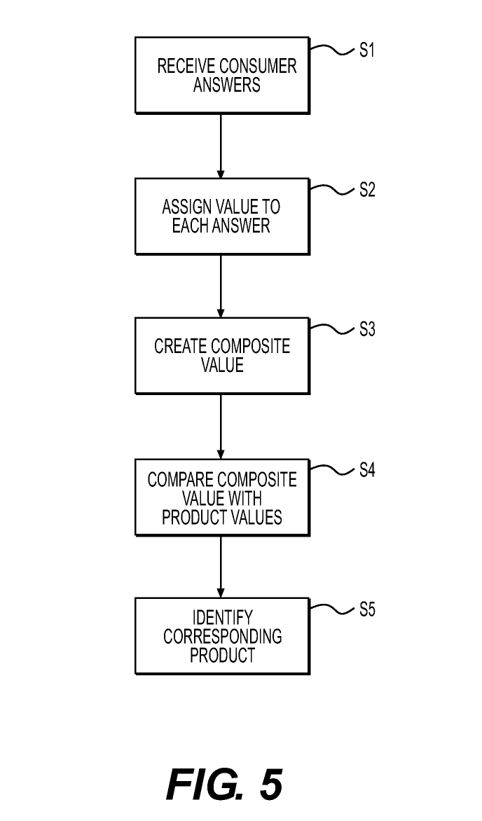

FIG. 5 shows a flowchart demonstrating a method of analyzing and predicting consumer behavior. At step S1 a plurality of questions answered by a consumer are received. The actual identity (e.g., name) of the consumer is not necessary—what is only needed is that the consumer be identified as a unique individual. Each question corresponds to at least one of the above-described product preference 22, mindset 24, attitudinal 26, influencer 28 and need state 30 sectors. Exemplary questions may include, for the product preference sector 22: “Would you prefer a whole burger, or a plate of burger sliders?”; for the mindset sector 24: “When learning about a new product, do you prefer to hear about the varieties on offer, or about the value you are getting for the money?”; for the attitudinal sector 26: “How much do you agree with the statement ‘I love to cook’?”; for the influencer sector 28: “When you seek out news, are you more likely to read articles about politics, or technology?”; and for the need state sector 30: “When eating a frozen snack, do you tend to be eating by yourself more often, or with a group?” Each segment of each sector has a unique value, and each unique value corresponds to one of a plurality of answers to each question. At step S2, the unique value is assigned to each user answer. At step S3, based on the assigned values of each user answer, the processing creates a composite value associating the consumer's identity with a particular lifestyle attitude sector 26a-26e, consumer mindset segment 24a-24e, product preference segment 22a-22d, influencer segment 28a-28t, and need state segment 30a-30h. In other words, the composite value includes a value from each of the lifestyle attitude segment 26a-26e, consumer mindset segment 24a-24e, product preference segment 22a-22d, influencer segment 28a-28t, and need state segment 30a-30h. This way, the consumer is “typed” for each of the five eating behavior sectors 22, 24, 26, 28 and 30. At step S4, the composite value is compared with a plurality of product values each associated with a respective plurality of products in a product database. As used herein, “product value” may refer to the value of any product or service as define above, including but not limited to a dollar value (e.g., assigning monetary “willingness to pay” values to specific product features and associated messages); brand equity (e.g., brand attributes and descriptors that consumers use to describe a brand, as well as key brand equity pillars, such as brand awareness); key concept and product ratings (e.g., purchase intent, liking, uniqueness, brand fit, purchase frequency, and the like; advertising metrics, such as recall, persuasion, and brand linkage); product testing ratings (e.g., product liking, fit with concept, or evaluations specific to product elements (for example, overall taste, spiciness level, mouth feel)); concept features (e.g., insight statement, benefit, reasons to believe); package features (e.g., color and graphic design, package shape and form, on-pack communication); early-stage product idea statements; and shelf sets/planograms. Optionally, at step S5, based on the compared composite value and product value, a corresponding product of the product database is identified.

For example, using the above-described method, the following exemplary implementation of the framework 300 may be performed. A producer, Company X, is interested in launching a frozen breakfast item and invites 100 consumers to take part in a central location test. In the test, each consumer is asked multiple questions that are related to the various five eating behavior sectors 22, 24, 26, 28 and 30. Using one of the 100 consumers (Consumer Y) answers to the questions, these are processed using computer system 100, which produces a statistical model (which includes the composite value). The model indicates that: Consumer Y's product choice=answer to attitudinal sector 26+answer to mindset sector 24+answer to product preference sector 22+answer to influencer sector 28+answer to need state sector 30 As an example, Consumer Y's model is: disciplinarian 26a+variety seeker (in fruit) 24c+high olfactory/low mechanical 22d+influenced by healthcare 28n and body image 28a+functional/control at breakfast 30e. Therefore, based on the computer system 100 comparing the values associated with Consumer Y's model, a corresponding product or range of products are determined, e.g., Consumer Y will more likely select a frozen mixed fruit smoothie for breakfast than a frozen egg and sausage breakfast sandwich. Alternatively, Consumer Y will more likely select a Frozen mixed fruit smoothie fortified with extra fiber for breakfast than a Frozen banana smoothie not fortified for breakfast.

Therefore, when Research & Development (R&D) is preparing prototypes for testing, the computer system 100 indicates that Consumer Y should be presented with a frozen mixed fruit smoothie to test, and (based on the statistical model) R&D would not waste company resources preparing for Consumer Y a frozen breakfast sandwich or a frozen banana smoothie that is not fortified.

Screening questions may be presented to consumers for the implementation of the framework 300. These questions may be given in a form of a scenario, multiple or single choice, a list, a Discriminant Function Analysis (DFA), CHAID (Chi Squared Automatic Interaction Detector), a scale, a ranking, agreement statements etc. For attitudinal sector identification, the questions will be focused on the consumer's perception of their lifestyle (diet, family life, exercise, etc.) and how aspects of food and beverage choice and consumption fit into that lifestyle (taste, health, convenience). For the mindset sector identification, the questions will be focused on the consumer's perception of the types of ways they like any product/service to be described/messaged to them, as well as the types of benefits they typically desire in a given product category (i.e. variety, value, endorsement, etc). For the product preference segment identification, the questions will be focused on understanding what types of products they prefer. For identification of what influencers are currently impacting the consumer in their decisions, the questions may ask the consumer what sort of media, stories, articles the consumer most seeks out to read or what types of things are they most concerned about or value the most when they make decisions. For identification of what need states are impacting the consumer, questions may focus on identifying the key occasion elements of consumption (i.e. special vs. everyday, alone vs. with others, etc) and then ask about emotional motivations that drive that occasion.

### Composite Computer Behavior Indicator

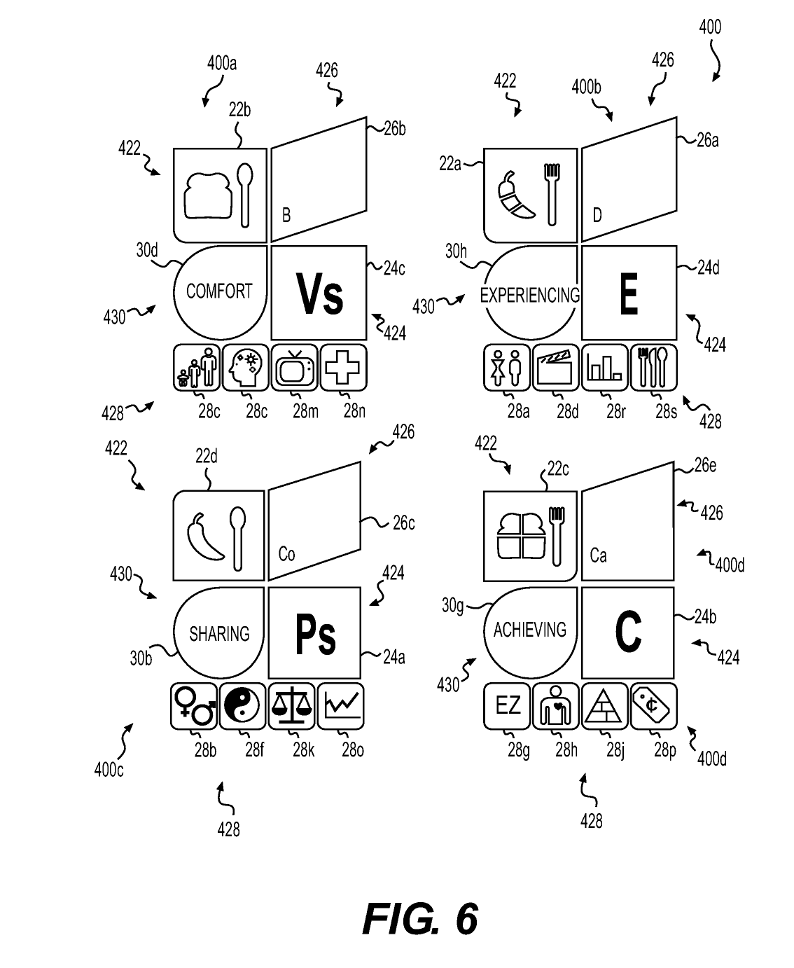

In order for producers to be able to quickly and accurately refer to different consumer types, a feature of the disclosure provides a composite consumer behavior indicator (characterization/typing) (alternatively referred to as a composite consumer behavior image, a composite consumer behavior representation and/or a composite consumer typing characterization) 400, four examples 400a, 400b, 400c, 400d shown in FIG. 6 which is a graphical representation of each of the five sectors 22, 24, 26, 28, 30 of the consumer behavior framework 300, and is produced by the computer system 100. Each characterization represents a statistical model (which includes the composite value) for each unique consumer. Generally speaking, the upper left section 422 of each indicator 400 indicates the product preference segment 22a-22d of product preference sector 22, the upper right section 426 indicates the lifestyle attitude segment 26a-26e of lifestyle attitude sector 26, the lower right section 424 indicates the consumer mindset segment 24a-24e of consumer mindset sector 24, the lower left section 430 indicates the need state segment 30a-30h of need state sector 30, and the bottom section 428 indicates the influencer segment 28a-28t of influencer sector 28.

Referring to the product preference sector 22, according to an aspect of the disclosure, the olfactory (flavor level) component is shown in a box as either a slice of bread (for low olfactory) or a hot pepper (for high olfactory), and the mechanical (texture level) component is shown in the box as either a spoon (for low mechanical) and a fork (for high mechanical), although those skilled in the art would appreciate that other icons or indicia or other shapes, patterns, dimensions, shades, colors and the like may be used.

Referring to the attitudinal sector 26, according to an aspect of the disclosure, each attitudinal segment 26a-26e is shown as a box with the first one or two letters of the segment name, and is further shown in different degrees of shading (of the same or different color), is used for each attitudinal segment, although those skilled in the art would appreciate that other icons or indicia or other shapes, patterns, dimensions, shades, colors and the like may be used.

Referring to the consumer mindset sector 24, according to an aspect of the disclosure, each consumer mindset segment 24a-24e is shown as a box with the first one or two letters or an abbreviation of the segment name, is used for each mindset segment, and is to be represented in different colors, although those skilled in the art would appreciate that other icons or indicia or other shapes, patterns, dimensions, shades, colors and the like may be used.

Referring to the need state sector 30, according to an aspect of the disclosure, each need state segment 30a-30h is shown as a box with the segment name listed, and is further shown in different colors, is used for each attitudinal segment, although those skilled in the art would appreciate that other icons or indicia or other shapes, patterns, dimensions, shades, colors and the like may be used.

Referring to the influencer sector 28, according to an aspect of the disclosure, one or more influencer segments 28a-28t is shown as a miniature box with an icon representing the influencer segment. More than one influencer segment is typically displayed in the indicator 400, since each unique consumer is generally influenced by more than one segment. Although four segments are shown, fewer or greater than four segments may be shown, depending on how many influencer influence the consumer. FIGS. 7A and 7B together show icons representing the influencers 28a-28t, with FIG. 7A showing the internal influencers, and FIG. 7B showing the external influencers. Those skilled in the art would appreciate that aside from a miniature box and/or icon, other icons or indicia or other shapes, patterns, dimensions, shades, colors and the like may be used.

Thus, from reviewing the four examples 400a, 400b, 400c, 400d shown in FIG. 6, it can be seen that the statistical model (which includes the composite value) for the unique consumer typed/identified in 400a (which represents a female consumer in her 20's) is: balancer 26b+variety seeker 24c+low olfactory/low mechanical 22b+comfort 30d+influenced by life stages 28c, loci of decision 28e, media 28m and healthcare 28n. Further, for the unique consumer typed/identified in 400b (which represents a female consumer in her 30's) is: disciplinarian 26a+experiencer 24d+high olfactory/high mechanical 22a+experiencing 30h+influenced by body image 28a, culture 28d, population statistics 28r and food industry 28a; for the unique consumer typed/identified in 400c (which represents a female consumer in her 40's) is: conflicted 26c+permission seeker 24a+high olfactory/low mechanical 22d+sharing 30b+influenced by life roles 28b, spirituality 28f, litigation 28k and business associations 28o; and for the unique consumer typed/identified in 400d (which represents a female consumer in her 60's) is: carefree 26e+classic 24b+low olfactory/high mechanical 22c+achieving 30g+influenced by convenience 28g, internal health 28h, regulatory 28j and trade/channel 28p. Thus, from viewing FIG. 6, it can be seen that the segments for each of the five sectors 22, 24, 26, 28, 30 can change or be modified with age.

According to a feature of the disclosure, the reader may view any given composite consumer behavior indicator 400 and quickly type/identify the unique consumer, since each indicator 400 includes the segments for each of the five sectors 22, 24, 26, 28, 30. While the above-described aspect describes an indicator 400 readable by the human eye, it is appreciated to those of skill in the art that in addition or alternatively to being readable by the human eye, the indicator may also be readable by a machine via, e.g., a QR Code.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for Internet and other packed switched network transmission (e.g., WiFi, Bluetooth, femtocell, microcell and the like) represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is not intended be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of analyzing and predicting consumer behavior, comprising:
receiving a plurality of consumer answers to a corresponding plurality of questions, each answer of the plurality of consumer answers input by a consumer having a unique consumer identity, each question of the plurality of questions corresponding to at least one of the following sectors:
a lifestyle attitude sector comprising a plurality of lifestyle attitude segments, each of which correspond to a different consumer attitude toward a lifestyle;
a consumer mindset sector comprising a plurality of consumer mindset segments, each of which corresponds to a different manner in which the consumer prefers to receive product information;
a product preference sector comprising a plurality of product preference segments, each of which corresponds to a different product quality desired to be experienced by the consumer;
an influencer sector comprising a plurality of influencer segments, each of which corresponds to a different factor that influences the consumer's behavior; and
a need state sector comprising a plurality of need state segments, each of which corresponds to a different consumer emotional need on a consuming occasion;
assigning a value to each user answer;
creating, based on the assigned values of each user answer and using a computer processor, a composite value associating the consumer identity with a particular lifestyle attitude segment, consumer mindset segment, product preference segment, influencer segment, and need state segment; and
comparing, via a comparator, the composite value with a plurality of product values each associated with a respective plurality of products in a product database.

2. The method according to claim 1, wherein the product is a food product.

3. The method according to claim 1, further comprising identifying, based on the compared composite value and product value, a corresponding product of the product database.

4. The method according to claim 3, further comprising presenting the consumer with the identified corresponding product.

5. The method according to claim 4, further comprising recording the consumer's judgment regarding the identified corresponding product.

6. The method according to claim 1, wherein the plurality of lifestyle attitude segments comprises five lifestyle attitude segments.

7. The method according to claim 1, wherein the plurality of consumer mindset sectors comprises five consumer mindset segments.

8. The method according to claim 2, wherein the plurality of product preference sectors comprises four product preference segments, each segment comprising a food olfactory strength value and a food mechanical value.

9. The method according to claim 8, wherein the plurality of product preference sectors further comprises a product size preference value.

10. The method according to claim 1, wherein the plurality of influencer segments comprises twenty influencer segments, each influencer segment comprising one of an internal influence and an external influence.

11. The method according to claim 1, wherein the plurality of need state segments comprises eight need state segments, each need state segment corresponding to a personal dimension in a range between pleasure and control, and further corresponding to a social dimension in a range between individuality and conformity.

12. The method according to claim 1, wherein the product is one of a product, marketing message, a service, a brand, one or more groups of products, and a package.

13. At least one processor for analyzing and predicting consumer behavior, the processor configured to:
receive a plurality of lifestyle attitude segment values, each of which correspond to a different consumer attitude toward a lifestyle;
receive a plurality of consumer mindset segment values, each of which corresponds to a different manner in which the consumer prefers to receive product information;
receive a plurality of product preference segment values, each of which corresponds to a different product quality desired to be experienced by the consumer;
receive a plurality of influencer segment values, each of which corresponds to a different factor that influences the consumer's behavior; and
receive a plurality of need state segment values, each of which corresponds to a different consumer emotional need on a consuming occasion.

14. At least one computer that executes an application for generating a composite consumer behavior image, comprising:
a memory that stores the application; and
a processor that executes the application, wherein the application, when executed by the processor, causes the computer at least to:
generate one of a plurality of lifestyle attitude sub-images, each of which represents a different consumer attitude toward a lifestyle;
generate one of a plurality of consumer mindset sub-images, each of which represents a different manner in which the consumer prefers to receive product information;
generate one of a plurality of product preference sub-images, each of which represents a different product quality desired to be experienced by the consumer;
generate at least one of a plurality of influencer sub-images, each of which represents a different factor that influences the consumer's consuming behavior; and
generate one of a plurality of need state sub-images, each of which represents a different consumer emotional need on a consuming occasion, wherein:
the generated lifestyle attitude sub-image, consumer mindset sub-image, product preference sub-image, influencer sub-image, and need state sub-image together form the composite consumer behavior image.

15. At least one computer that executes an application for analyzing and predicting consumer behavior, comprising:
at least one memory that stores the application; and
at least one processor that executes the application, wherein the application, when executed by the at least one processor, causes the computer at least to:
receive a plurality of consumer answers to a corresponding plurality of questions, each answer of the plurality of consumer answers input by a consumer having a unique consumer identity, each question of the plurality of questions corresponding to at least one of the following sectors:
a lifestyle attitude sector comprising a plurality of lifestyle attitude segments, each of which correspond to a different consumer attitude toward a lifestyle;
a consumer mindset sector comprising a plurality of consumer mindset segments, each of which corresponds to a different manner in which the consumer prefers to receive product information;
a product preference sector comprising a plurality of product preference segments, each of which corresponds to a different product quality desired to be experienced by the consumer;
an influencer sector comprising a plurality of influencer segments, each of which corresponds to a different factor that influences the consumer's consuming behavior; and
a need state sector comprising a plurality of need state segments, each of which corresponds to a different consumer emotional need on a consuming occasion;
assign a value to each user answer;
create, based on the assigned values of each user answer and using a computer processor, a composite value associating the consumer identity with a particular lifestyle attitude segment, consumer mindset segment, product preference segment, influencer segment, and need state segment; and
compare the composite value with a plurality of product values each associated with a respective plurality of products in a product database.

16. At least one non-transitory computer readable medium for analyzing and predicting consumer behavior, the medium comprising:
a receiving code segment which, when executed by the computer, receives a plurality of consumer answers to a corresponding plurality of questions, each answer of the plurality of consumer answers input by a consumer having a unique consumer identity, each question of the plurality of questions corresponding to at least one of the following sectors:
a lifestyle attitude sector comprising a plurality of lifestyle attitude segments, each of which correspond to a different consumer attitude toward a lifestyle;
a consumer mindset sector comprising a plurality of consumer mindset segments, each of which corresponds to a different manner in which the consumer prefers to receive product information;
a product preference sector comprising a plurality of product preference segments, each of which corresponds to a different product quality desired to be experienced by the consumer;
an influencer sector comprising a plurality of influencer segments, each of which corresponds to a different factor that influences the consumer's consuming behavior; and
a need state sector comprising a plurality of need state segments, each of which corresponds to a different consumer emotional need on a consuming occasion;
an assigning code segment that assigns a value to each user answer;
a creating code segment which, when executed by the computer, creates, based on the assigned values of each user answer and using a computer processor, a composite value associating the consumer identity with a particular lifestyle attitude segment, consumer mindset segment, product preference segment, influencer segment, and need state segment; and
a comparing code segment which, upon executed by the computer, compares, using a comparator, the composite value with a plurality of product values each associated with a respective plurality of products in a product database.

17. The method according to claim 2, wherein each lifestyle attitude segment of the plurality of lifestyle attitude segments comprise a different taste percentage value, convenience percentage value and health percentage value, wherein the taste, convenience and health percentage values total 100%.
